(19) United States
(12) Patent Application Publication
(10) Pub. No.: US 2025/0058665 A1
(43) Pub. Date: Feb. 20, 2025

(54) SEQUENTIAL CLOSING OF ELECTRIC VEHICLE SUPPLY EQUIPMENT CONTACTORS

(71) Applicant: FORD GLOBAL TECHNOLOGIES, LLC, Dearborn, MI (US)

(72) Inventors: Haider MHIESAN, Dearborn, MI (US); Mohamad MOKBEL, Farmington Hills, MI (US); Timothy HARRIS, Grosse Ile, MI (US); Christopher BALLARD, Redford, MI (US)

(21) Appl. No.: 18/234,563

(22) Filed: Aug. 16, 2023

(51) Int. Cl. B60L 53/62; B60L 53/16; H02J 7/00

(52) U.S. Cl. CPC B60L 53/62; B60L 53/16; H02J 7/00712; B60L 2270/20

(57) ABSTRACT

Electric vehicle supply equipment may include a pair of parallel contactors that electrically connect a vehicle with a power source. It also includes a controller that closes one of the pair before the other of the pair based on a cumulative exposure to in-rush current of each of the pair.

### TECHNICAL FIELD

The present disclosure relates to operating electric vehicle supply equipment (EVSE) for providing electric energy to a vehicle.

### BACKGROUND

Electric vehicles may rely on one or more traction batteries to provide electrical energy to a motor for propulsion. The traction batteries may be recharged by a power source through EVSE.

### SUMMARY

A vehicle charging system has electric vehicle supply equipment including a pair of contactors that electrically connect a vehicle with a power source, and a controller that closes one of the pair before the other of the pair based on a cumulative exposure to in-rush current of each of the pair.

A method includes, following connection of electric vehicle supply equipment to a vehicle, sequentially closing a pair of parallel contactors that electrically connect the vehicle with a power source such that a last of the pair to be closed is closed based on a zero-voltage crossing of power associated with the power source and a first of the pair to be closed is not closed based on a zero-voltage crossing of the power.

Electric vehicle supply equipment has a charge line including a pair of contactors and a controller. The controller, after the charge line has been connected to a vehicle, sequentially closes the pair such that a first of the pair to be closed is closed based on a cumulative exposure to in-rush current of each of the pair and a second of the pair to be closed is closed based on a zero-voltage crossing of power associated with a grid.

### BRIEF DESCRIPTION OF THE DRAWINGS

FIG. 1 illustrates an example block topology of an electrified vehicle with drivetrain and energy storage components.

FIG. 2 illustrates an example block diagram of an EVSE with high-voltage buses and contactors.

FIG. 3 illustrates an example flow diagram of a process for operating the EVSE to charge the vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for controlling an EVSE to charge an electric vehicle.

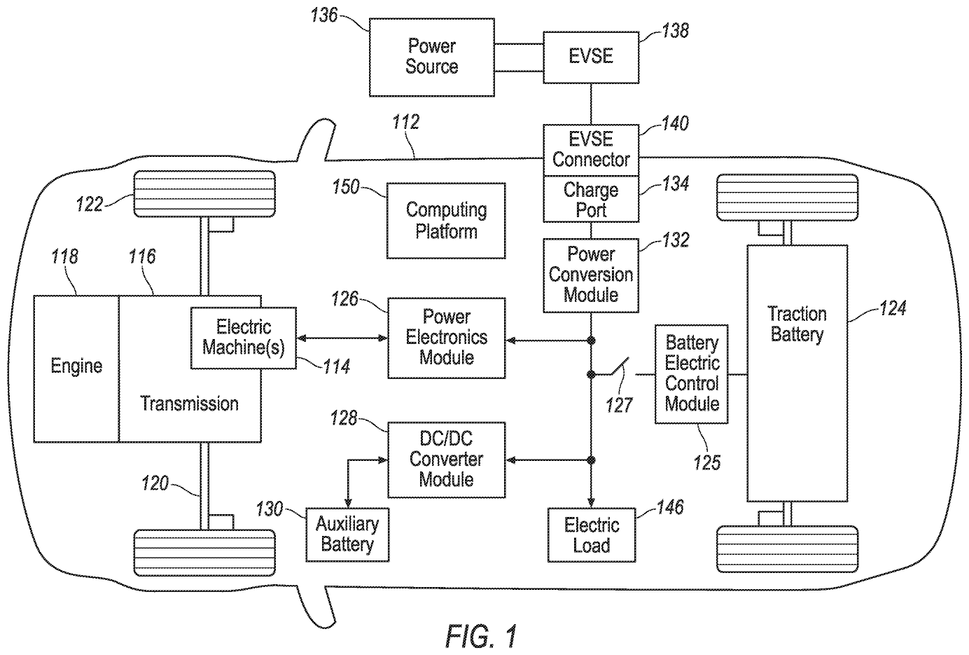

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 may provide propulsion and braking capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g. a server) via a wireless network (e.g. a cellular network).

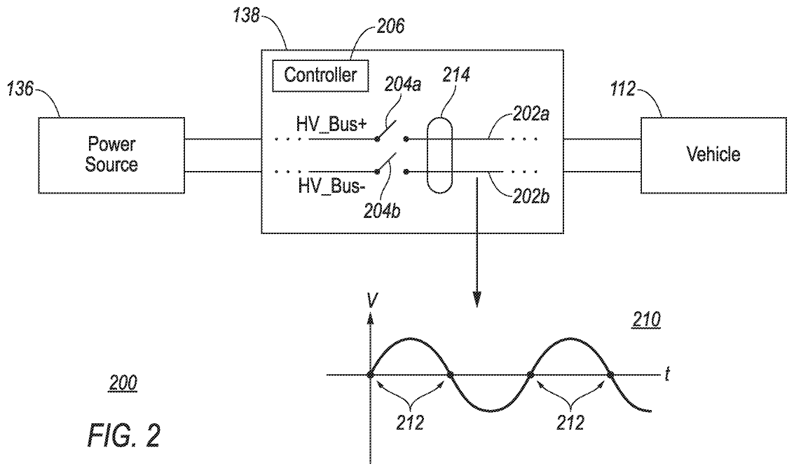

The system controller 150 and/or BECM 125, individually or combined, may be programmed to perform various operations with regard to the traction battery 124. For instance, the system controller 150 and/or BECM 125 may be configured to communicate with the EVSE 138 to operate and facilitate the battery charging process. Referring to FIG. 2, an example block diagram of an EVSE 138 and a part of the EVSE circuit is illustrated. With continuing reference to FIG. 1, the EVSE 138 may be configured to receive an AC current from the power source 136 on a power source side. The EVSE 138 may be further configured to output an AC current to the vehicle 112 on a vehicle side. A positive high-voltage (HV) bus 202a and a negative HV bus 202b may be connected between the power source side and the vehicle side of the EVSE circuit and configured to convey electric energy between the power source 136 and the vehicle 112. In one example, the positive and negative HV buses 202a, 202b may be directly connected between the power source side and vehicle side such that the AC current received from the power source 136 and AC current output to the vehicle 112 are associated with the same properties (e.g. voltage, frequency or the like). Alternatively, if the AC current output to the vehicle 112 has different properties from the AC current received from the power source, additional circuitries (not shown) may be provided to the EVSE 138 to facilitate the power transformation. In the present disclosure, a positive main contactor MC+ 204a may be disposed on the positive HV bus 202a and a negative main contactor MC-204b may be disposed on the negative HV bus 202b. The main contactors 204a and 204b may selectively open and close to connect the power source side and the vehicle side of the EVSE 138.

Operations of the main contactors 204a and 204b may be controlled by an EVSE controller 206. The EVSE controller 206 may be configured to control the opening and closing of the main contactors 204a and 204b based on various factors obtained from the vehicle 112 and the power source 136. For instance, the EVSE 138 may be provided with communication capabilities to communicate with the vehicle 112 and receive information with regard to the condition of the traction battery 124 (e.g. battery SOC, temperature). As discussed above, the system controller 150 and BECM 125 of the vehicle 112 may communicate with the EVSE 138 and provide the information about the traction battery 124 to facilitate the vehicle charging. Responsive to detecting the EVSE connector 140 is coupled with the vehicle 112, a data communication may be established between the EVSE 138 and the vehicle 112 in preparation for the charging. The controller 206 may start the charging process by closing both the main contactors 204a and 204b. A method is to sequentially close the main contactors 204a and 204b one after another with a short period of time in between. For instance, the positive main contactor 204a may be closed first and the negative main contactor 204b may be closed subsequently. In this example, the power source 136 is not connected to the vehicle 112 until the negative (i.e. subsequent) main contactor 204b is closed. The EVSE controller 206 may swap the closing sequence between the positive and negative main contactors 204a and 204b such that the contacts may have an even wear condition.

As discussed above, AC current is supplied to the vehicle 112 to charge the traction battery 124. The AC current on the positive HV bus 204a and the negative HV bus 204b may be in the form of a sinusoidal wave as illustrated in the waveform diagram 210. To further minimize the influence of in-rush current, the controller 206 may be configured to operate the main contactors 204a and 204b to close at a zero-voltage crossing point 212 as illustrated in the waveform diagram 210. Alternatively, since the charging circuit is not complete and thus no in-rush current occurs when only the first main contactor is closed, the first contactor may be closed at any time regardless of the phase of the waveform. The EVSE controller 206 may be configured to only command the subsequent main contactor to close at the zero-voltage crossing point 212 to mitigate the in-rush current. Despite the effort to mitigate the in-rush current, the timing to close the second main contactor may not be 100% accurate due to various factors. A small amount of in-rush current may still be generated once the charging circuit is closed upon the closing of the subsequent main contactor. The EVSE 138 may be further provided with one or more current sensors 214 to monitor the current on the positive and negative HV buses 202a and 202b.

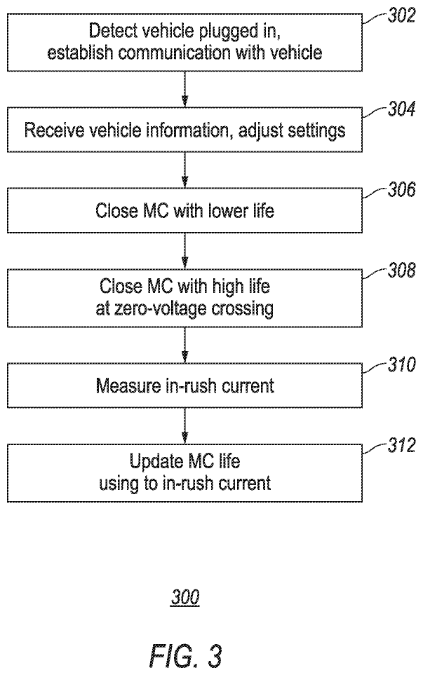

Referring to FIG. 3, an example flow diagram of a process 300 for operating the EVSE is illustrated. With continuing reference to FIGS. 1 and 2, the process 300 may be implemented via the EVSE controller 206. At operation 302, responsive to detecting the vehicle 112 has connected to the EVSE 138 via the connector 140, the EVSE controller 206 establishes a data communication link with the vehicle 112. As discussed above, the EVSE controller 206 may be configured to communicate with the system controller 150 as well as the BECM 125 via the EVSE connector 140 configured to support data communication protocols. Additionally or alternatively, one or more wireless communication link (e.g. Wi-Fi) may be established between the EVSE 138 and the vehicle 112 to enable data communications. At operation 304, the EVSE controller 206 receives vehicle information related to the battery charging from the vehicle 112. The vehicle information may include various entries that may be used to operate the EVSE 138 to control the battery charging process. For instance, the vehicle information may include a present SOC that is used as a starting SOC to charge the traction battery 124. As a general rule, a lower starting SOC (e.g. 20%) may be associated with a higher starting charging power and thus possibly a higher in-rush current when the second main contactor 204 is closed. In contrast, a higher starting SOC (e.g. 70%) may be associated with a lower starting charging power and thus possibly a lower in-rush current. The vehicle information may further include a temperature of the traction battery 124 measured by a temperature sensor (not shown). The vehicle information may further include a battery and charging configuration (e.g. voltage, power limit) associated with the traction battery 124. Once the vehicle information is received, the EVSE controller 206 adjusts the settings accordingly in preparation of the charging process.

At operation 306, the EVSE 206 operates one of the main contactors 204 with a lower life (greater cumulative exposure in-rush current) to close such that one of the positive or negative HV buses 202a, 202b is connected between the power source side and the vehicle side. Subsequently at operation 308, the EVSE controller 206 operates the other main contactor with a higher life (e.g. better condition) to close such that the charging circuit is activated to start charging the traction battery 124. The positive and negative main contactors 204a, 204b may be associated with different lives/conditions depending on the usage history. For instance, a main contactor 204 subject to more frequent and higher magnitude in-rush current may be associated with a lower life as compared with the other main contactor 204 subject to less frequent and lower magnitude in-rush current. The life/condition of each main contactor may be evaluated based on various factors (to be discussed below) and recorded in a memory that is accessible by the EVSE controller 206. Since the charging circuitry is not activated until the second main contact is closed, the first main contactor to close will have a lesser amount of life compared with the second main contactor to close. Therefore, a more even life shared between the two main contactors 204 may be achieved.

At operation 310, the EVSE controller 206 measures the in-rush current generated by the closing of the second main contactor via one of the current sensors 214. As discussed above, in an ideal situation, the in-rush current should be zero because the controller 206 commands the second main contactor 204 to close at the zero-voltage crossing point. However, the timing control to close the second main contactor 204 at zero-voltage crossing may not be completely accurate and a small amount of in-rush current may be generated. At operation 312, the EVSE controller 206 evaluates the in-rush current's influence to the life depreciation of the second main contactor and updates the life property associated with the second main contactor. The life depreciation of the second main contactor 204 may be quantified and evaluated in various manners. For instance, a higher in-rush current (e.g. 10A) may be evaluated to cause an equivalent of a higher life depreciation (e.g. 0.1%) whereas a lower in-rush current (e.g. 2A) may be evaluated to cause an equivalent of a lower life depreciation (e.g. 0.02%). The EVSE 206 records the updated life property of the second main contactor 204 in the memory. The next time a vehicle charging starts, the EVSE 206 determines the sequence to close the main contactors 204 based on updated life properties of both main contactors.

There are alternative methods to evaluate the main contactor depreciations other than using the in-rush current as measured. For instance, the EVSE controller 206 may be configured to evaluate the life depreciation of the main contactors 204 based on the starting SOC of the traction battery 124 in addition to or in lieu of the in-rush current as measured by the current sensor 214. In general, a lower starting SOC of the traction battery 124 may be associated with a higher amount of in-rush current and a higher starting SOC of the traction battery 124 may be associated with a lower amount of in-rush current. Therefore, a lower starting SOC may be evaluated to cause an equivalent of a higher life depreciation and a higher starting SOC may be evaluated to cause an equivalent of a lower life depreciation.

Additionally or alternatively, the EVSE 206 may be further configured to swap the closing sequence of the main contactors each time a new charging process starts regardless of the in-rush current or starting SOC.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle charging system comprising:
electric vehicle supply equipment including a pair of contactors configured to electrically connect a vehicle with a power source, and a controller programmed to close one of the pair before the other of the pair based on a cumulative exposure to in-rush current of each of the pair.

2. The vehicle charging system of claim 1, wherein the controller is further programmed to close the other of the pair based on a zero-voltage crossing of power associated with the power source.

3. The vehicle charging system of claim 1, wherein the cumulative exposure to in-rush current of the one of the pair is greater than that of the other of the pair.

4. The vehicle charging system of claim 1, wherein the controller is further programmed to update a parameter indicative of the cumulative exposure to in-rush current of the one of the pair or update a parameter indicative of the cumulative exposure to in-rush current of the other of the pair.

5. The vehicle charging system of claim 1, wherein the controller is further programmed to close the one of the pair before the other of the pair responsive to a request for charging of the vehicle.

6. The vehicle charging system of claim 1, wherein the pair are in parallel.

7. A method comprising:
following connection of electric vehicle supply equipment to a vehicle, sequentially closing a pair of parallel contactors configured to electrically connect the vehicle with a power source such that a last of the pair to be closed is closed based on a zero-voltage crossing of power associated with the power source and a first of the pair to be closed is not closed based on a zero-voltage crossing of the power.

8. The method of claim 7 further comprising closing the first of the pair based on a cumulative exposure to in-rush current of the first of the pair.

9. The method of claim 8, wherein the cumulative exposure to in-rush current of the first of the pair is greater than that of the last of the pair.

10. The method of claim 8 further comprising updating a parameter indicative of the cumulative exposure to in-rush current of the first of the pair or updating a parameter indicative of exposure to in-rush current of the last of the pair.

11. The method of claim 8, wherein the sequentially closing is responsive to a request to charge the vehicle.

12. Electric vehicle supply equipment comprising:
a charge line including a pair of contactors; and
a controller programmed to, after the charge line has been connected to a vehicle, sequentially close the pair such that a first of the pair to be closed is closed based on a cumulative exposure to in-rush current of each of the pair and a second of the pair to be closed is closed based on a zero-voltage crossing of power associated with a grid.

13. The electric vehicle supply equipment of claim 12, wherein the cumulative exposure to in-rush current of the first of the pair is greater than a cumulative exposure to in-rush current of the second of the pair.

14. The electric vehicle supply equipment of claim 12, wherein the controller is further programmed to update a parameter indicative of the cumulative exposure to in-rush current of the first of the pair or update a parameter indicative of the cumulative exposure to in-rush current of the second of the pair.

15. The electric vehicle supply equipment of claim 12, wherein the controller is further programmed to sequentially close the pair responsive to a request for charging the vehicle.

16. The electric vehicle supply equipment of claim 12, wherein the pair are in parallel.
